(19) United States
(12) Patent Application Publication
(10) Pub. No.: US 2009/0279612 A1
(43) Pub. Date: Nov. 12, 2009

(54) Methods and apparatus for multi-view video encoding and decoding

(76) Inventors: Purvin Bibhas Pandit, Franklin Park, NJ (US); Yeping Su, Vancouver, WA (US); Peng Yin, West Windsor, NJ (US); Cristina Gomila, Princeton, NJ (US)

Correspondence Address: Thomson Licensing LLC, P.O. Box 5312, Two Independence Way, PRINCETON, NJ, 08543-5312, US

(21) Appl. No.: 12/308,791

(22) PCT Filed: May 25, 2007
(86) PCT No.: PCT/US07/12452

§ 371 Date: Dec. 23, 2008

Related U.S. Application Data
(60) Provisional application No. 60/818,655, filed on Jul. 5, 2006.

(51) Int. Cl. H04N 7/26

(52) U.S. Cl. 375/240.25; 375/240.01; 375/E07.027

(57) ABSTRACT

There are provided methods and apparatus for multi-view video encoding and decoding. The apparatus includes an encoder for encoding at least two views corresponding to multi-view video content into a resultant bitstream using a syntax element. The syntax element identifies a particular one of at least two methods that indicate a decoding dependency between at least some of the at least two views.

### CROSS-REFERENCE TO RELATED APPLICATIONS

This application claims the benefit of U.S. Provisional Application Ser. No. 60/818,655, filed 5 Jul. 2006, which is incorporated by reference herein in its entirety.

### TECHNICAL FIELD

The present principles relate generally to video encoding and decoding and, more particularly, to methods and apparatus for multi-view video encoding and decoding.

### BACKGROUND

A Multi-view Video Coding (MVC) sequence is a set of two or more video sequences that capture the same scene from different view points. For efficient support of view random access and view scalability, it is important for the decoder to have knowledge of how different pictures in a multi-view video coding sequence depend on each other.

### SUMMARY

These and other drawbacks and disadvantages of the prior art are addressed by the present principles, which are directed to methods and apparatus for multi-view video encoding and decoding.

According to an aspect of the present principles, there is provided an apparatus. The apparatus includes an encoder for encoding at least two views corresponding to multi-view video content into a resultant bitstream using a syntax element, wherein the syntax element identifies a particular one of at least two methods that indicate a decoding dependency between at least some of the at least two views.

According to another aspect of the present principles, there is provided a method. The method includes encoding at least two views corresponding to multi-view video content into a resultant bitstream using a syntax element. The syntax element identifies a particular one of at least two methods that indicate a decoding dependency between at least some of the at least two views.

According to yet another aspect of the present principles, there is provided an apparatus. The apparatus includes a decoder for decoding at least two views corresponding to multi-view video content from a bitstream using a syntax element. The syntax element identifies a particular one of at least two methods that indicate a decoding dependency between at least some of the at least two views.

According to still another aspect of the present principles, there is provided a method. The method includes decoding at least two views corresponding to multi-view video content from a bitstream using a syntax element. The syntax element identifies a particular one of at least two methods that indicate a decoding dependency between at least some of the at least two views.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram for an exemplary video encoder to which the present principles may be applied, in accordance with an embodiment of the present principles;

FIG. 2 is a block diagram for an exemplary video decoder to which the present principles may be applied, in accordance with an embodiment of the present principles;

FIG. 3 is a flow diagram for an exemplary method for inserting a vps_selection_flag into a resultant bitstream, in accordance with an embodiment of the present principles; and

FIG. 4 is a flow diagram for an exemplary method for decoding a vps_selection_flag in a bitstream, in accordance with an embodiment of the present principles.

### DETAILED DESCRIPTION

The present principles are directed to method and apparatus for multi-view video encoding and decoding.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

As used herein, “high level syntax” refers to syntax present in the bitstream that resides hierarchically above the macroblock layer. For example, high level syntax, as used herein, may refer to, but is not limited to, syntax at the slice header level, Supplemental Enhancement Information (SEI) level, picture parameter set level, and sequence parameter set level.

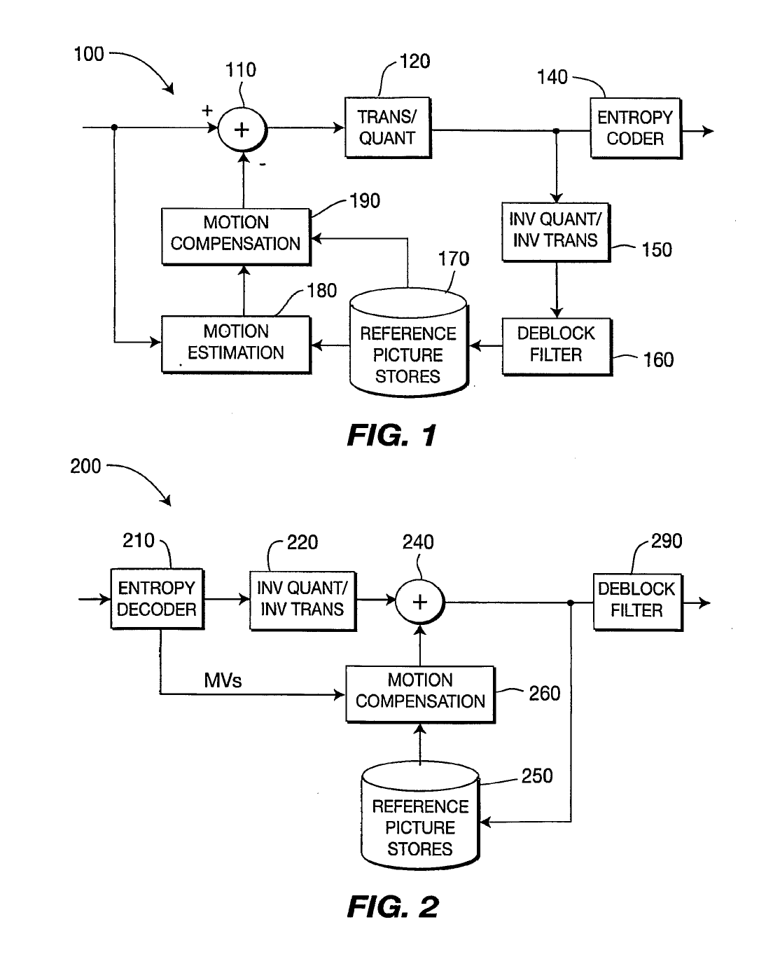

Turning to FIG. 1, an exemplary video encoder to which the present principles may be applied is indicated generally by the reference numeral 100.

An input to the video encoder 100 is connected in signal communication with a non-inverting input of a combiner 110. The output of the combiner 110 is connected in signal communication with a transformer/quantizer 120. The output of the transformer/quantizer 120 is connected in signal communication with an entropy coder 140. An output of the entropy coder 140 is available as an output of the encoder 100.

The output of the transformer/quantizer 120 is further connected in signal communication with an inverse transformer/quantizer 150. An output of the inverse transformer/quantizer 150 is connected in signal communication with an input of a deblock filter 160. An output of the deblock filter 160 is connected in signal communication with reference picture stores 170. A first output of the reference picture stores 170 is connected in signal communication with a first input of a motion estimator 180. The input to the encoder 100 is further connected in signal communication with a second input of the motion estimator 180. The output of the motion estimator 180 is connected in signal communication with a first input of a motion compensator 190. A second output of the reference picture stores 170 is connected in signal communication with a second input of the motion compensator 190. The output of the motion compensator 190 is connected in signal communication with an inverting input of the combiner 110.

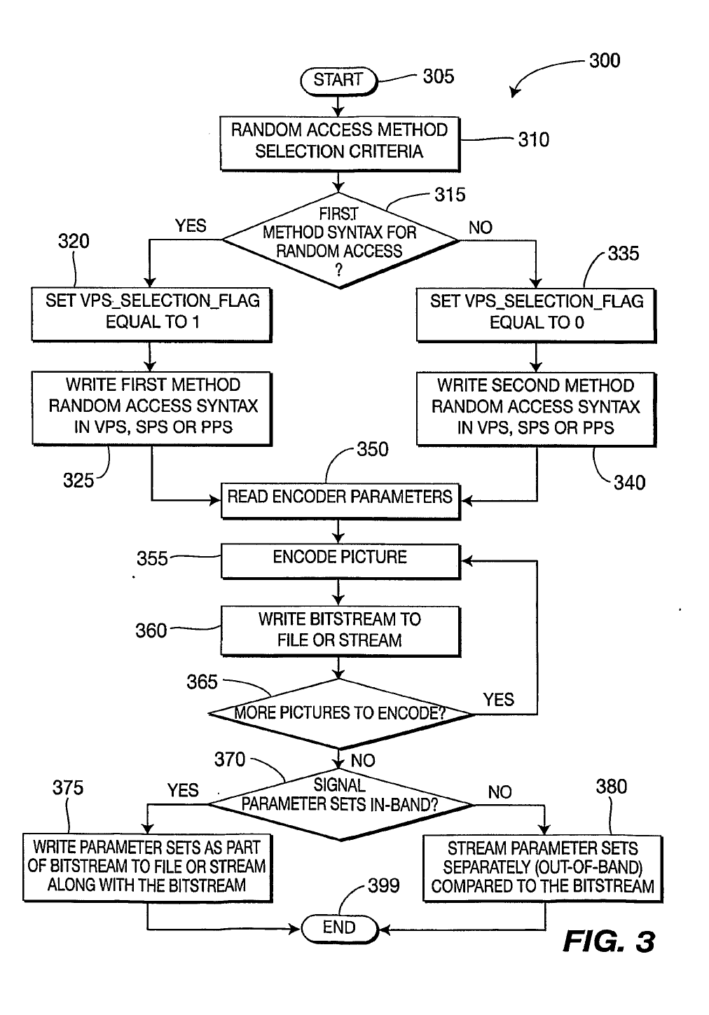

Turning to FIG. 2, an exemplary video decoder to which the present principles may be applied is indicated generally by the reference numeral 200.

The video decoder 200 includes an entropy decoder 210 for receiving a video sequence. A first output of the entropy decoder 210 is connected in signal communication with an input of an inverse quantizer/transformer 220. An output of the inverse quantizer/transformer 220 is connected in signal communication with a first non-inverting input of a combiner 240.

The output of the combiner 240 is connected in signal communication with an input of a deblock filter 290. An output of the deblock filter 290 is connected in signal communication with an input of a reference picture stores 250. The output of the reference picture stores 250 is connected in signal communication with a first input of a motion compensator 260. An output of the motion compensator 260 is connected in signal communication with a second non-inverting input of the combiner 240. A second output of the entropy decoder 210 is connected in signal communication with a second input of the motion compensator 260. The output of the deblock filter 290 is available as an output of the video decoder 200.

In accordance with the present principles, a method and apparatus for multi-view video encoding and decoding are provided. In an embodiment, changes to the high level syntax of the MPEG-4 AVC standard are proposed for efficient processing of a Multi-view video sequence. For example, in an embodiment, we propose including a flag or other syntax element to choose between different methods which indicate the dependency structure of the multi-view video sequence. By providing such a flag or other syntax element, an embodiment of the present principles allows a decoder to determine how different pictures in a multi-view video sequence depend on each other. In this way, advantageously only necessary pictures are decoded. Moreover, such view dependency information provides efficient support of view random access and view scalability.

Two different methods, hereinafter referred to as the “first method” and the “second method”, have been proposed to provide dependency information in multi-view compressed bit streams. Both methods propose changes to the high level syntax of the International Organization for Standardization/International Electrotechnical Commission (ISO/IEC) Moving Picture Experts Group-4 (MPEG-4) Part 10 Advanced Video Coding (AVC) standard/lnternational Telecommunication Union, Telecommunication Sector (ITU-T) H.264 recommendation (hereinafter the “MPEG-4 AVC standard”). In particular, they define a new parameter set called the View Parameter Set (VPS).

In the following description, it is presumed that a node corresponds to a picture in a video sequence. Each picture can be either independently coded or can be encoded dependent upon previously coded pictures. If the encoding of a picture depends on a previously coded picture, we call the referred picture (i.e., the previously coded picture) as a parent of the picture being encoded. A picture can have one or more parents. The descendent of a picture A is a picture which uses A as its reference.

The first method provides the dependency information in a local scope. This means that for each node the immediate parent is signaled. In this approach, we need to reconstruct the dependency graph using this dependency information. One way to reconstruct the dependency graph is have recursive calls to determine this graph.

The second method provides the dependency information in a global scope. This means that for each node the descendents are signaled. In effect, only a table look up can be used to determine whether an ancestor/descendent relationship exist between any two nodes.

The following syntax immediately hereinafter represents possible embodiments of the first and second methods for indicating dependency information in a multi-view video bitstream.

Table 1 shows the View Parameter Set (VPS) syntax for the first method for indicating dependency information in multi-view bitstreams.

TABLE 1

| view_parameter_set_rbsp( ) { | | Descriptor |
|---|---|---|
| | view_parameter_set_id | ue(v) |
| | num_multiview_refs_for_list0 | ue(v) |
| | num_multiview_refs_for_list1 | ue(v) |
| | for( i = 0; i < num_multiview_refs_for_list0; i++ ) { | |

| | |
|---|---|
| reference_view_for_list_0[i] | ue(v) |

}
for( i = 0; i < num_multiview_refs_for_list1; i++ ) {

| | |
|---|---|
| reference_view_for_list_1[i] | ue(v) |

}

}

view_parameter_set_id identifies the view parameter set that is referred to in the slice header. The value of the view_parameter_set_id shall be in the range of 0 to 2¹⁶−1.
num_multiview_refs_for_list0 specifies the number of multiview prediction references for list0. The value of num_multiview_refs_for_list0 shall be less than or equal to the maximum number of elements in list0.
num_multiview_refs_for_list1 specifies the number of multiview prediction references for list1. The value of num_multiview_refs_for_list1 shall be less than or equal to the maximum number of elements in list1.
reference_view_for_list_{—}0[i] identifies the view index of the view that is used as the ith reference for the current view for list 0.
reference_view_for_list_{—}1[i] identifies the view index of the view that is used as the ith reference for the current view for list 0.

Table 2 shows the View Parameter Set (VPS) syntax for the second method for indicating dependency information in multi-view bitstreams.

TABLE 2

| view_parameter_set_rbsp( ) { | | C | Descriptor |
|---|---|---|---|
| | view_parameter_set_id | 0 | ue(v) |
| | number_of_views_minus_1 | 0 | ue(v) |
| | avc_compatible_view_id | 0 | ue(v) |
| | for( i = 0; i <= number_of_views_minus_1; i++ ) { | | |

| | | |
|---|---|---|
| is_base_view_flag[i] | 0 | u(1) |

| | | |
|---|---|---|
| dependency_update_flag | 0 | u(1) |

if (dependency_update_flag == 1 ) {

for(j = 0; j < number_of_views_minus_1; j++) {

| | | |
|---|---|---|
| anchor_picture_dependency_maps[i][j] | 0 | f(1) |
| if (anchor_picture_dependency_maps[i][j] == 1) | | |

| | | |
|---|---|---|
| non_anchor_picture_dependency_maps[i][j] | 0 | f(1) |

}

}

}

view_parameter_set_id identifies the view parameter set that is referred to in the slice header. The value of the view_parameter_set_id shall be in the range of 0 to 255.
number_of_views_minus_{—}1 plus 1 identifies the total number of views in the bitstream. The value of the number_of_view_minus_{—}1 shall be in the range of 0 to 255.
avc_compatible_view_id indicates the view_id of the AVC compatible view. The value of avc_compatible_view_id shall be in the range of 0 to 255.
is_base_view_flag[i] equal to 1 indicates that the view i is a base view and is independently decodable. is_base_view_flag[i] equals to 0 indicates that the view i is not a base view. Value of is_base_view_flag[i] shall be equal to 1 for an AVC compatible view i.
dependency_update_flag equal to 1 indicates that dependency information for this view is updated in the VPS. dependency_update_flag equals to 0 indicates that the dependency information for this view is not updated and should not be changed.
anchor_picture_dependency_maps[i] [ ] equal to 1 indicates the anchor pictures with view_id equals to j will depend on the anchor pictures with view_id equals to i.
non_anchor_picture_dependency_maps[i] [j] equal to 1 indicates the non-anchor pictures with view_id equals to j will depend on the non-anchor pictures with view_id equals to i. non_anchor_picture_dependency_maps[i] [j] is present only when anchor_picture_dependency_maps[i] [i] equals 1. If anchor_picture_dependency_maps[i] [j] is present and equals to zero
non_anchor_picture_dependency_maps[i] [j] shall be inferred as 0.

Both methods rely on the definition of a new picture type called an Anchor picture.
Anchor picture: A coded picture in which all slices reference only slices with the same temporal index, i.e., only slices in other views and not slices in the current view. Such a picture is signaled by setting the nal_ref_idc=3. After decoding the anchor picture, all following coded pictures in display order shall be able to be decoded without inter-prediction from any picture decoded prior to the anchor picture. If a picture in one view is an anchor picture, then all pictures with the same temporal index in other views shall also be anchor pictures.

Two independent changes are indicating the breaking of temporal dependency by having the anchor picture require the marking of preceding pictures in display order as unused for reference (shown in italics), and/or by requiring anchor pictures to be aligned across views (shown in bold and italics).

Both the first method and the second method introduce new NAL unit types as indicated in bold in Table 4. Besides, both approaches also modify the slice header to indicate the View Parameter Set to be used and also the view_id as shown in Table 5.

The first method has the advantage of handling cases where the base view can change over time, but it requires additional buffering of the pictures before deciding which pictures to discard. The first method also has the disadvantage of having a recursive process to determine the dependency.

In contrast, the second method does not require any recursive process and does not require buffering of the pictures if the base view does not change. However, if the base view does change over time, then the second method also requires buffering of the pictures.

It is to be appreciated that while the present principles are primarily described with respect to two methods for indicating dependency information in a multi-view video bitstream, the present principles may be applied to other methods for indicating dependency information in a multi-view video bitstream, while maintaining the scope of the present principles. For example, the present principles may be implemented with respect to the other methods in place of and/or in addition to one or more of the two methods for indicating dependency information described herein.

In accordance with the present principles, new syntax is proposed for introduction in a multi-view video bitstream, where the new syntax is for use in selecting between different methods that indicate the dependency structure of one or more pictures in the bitstream. In an embodiment, this syntax is a high level syntax. As noted above, the phrase “high level syntax” refers to syntax present in the bitstream that resides hierarchically above the macroblock layer. For example, high level syntax, as used herein, may refer to, but is not limited to, syntax at the slice header level, Supplemental Enhancement Information (SEI) level, picture parameter set level, and sequence parameter set level. In an embodiment, depending on the value of such syntax, the decoder can recognize the subsequent syntax elements belonging to a particular method of indicating dependency structure. In an embodiment, this syntax can then be stored in the decoder and processed at a later time when such need arises.

Selecting between only two methods to indicate dependency structure can be considered a special case of the new syntax in accordance with the present principles. In such a case, this syntax element can take only two values. As a result, in an embodiment, this can simply be a binary valued flag in the bitstream. One such exemplary embodiment is discussed below.

Let us presume that for an MPEG-4 AVC bitstream, one of the methods is based on providing this dependency information in a local scope, such as the first method described above. This means, that for each node the immediate parent is signaled. In this approach, we need to reconstruct the dependency graph using this information. One way would be to have recursive calls to determine this graph.

In the second method, the dependency information is on a global scope. This means that for each node we signal the descendents. In effect, only a table look up can be used to determine whether an ancestor/descendent relationship exist between any two nodes.

In an embodiment, we introduce a flag at a high level of the bitstream to indicate which of the two methods is signaled in the bitstream. This can be signaled either in the Sequence Parameter Set (SPS), the View Parameter Set (VPS) or some other special data structure present at the high level of the MPEG-4 AVG bitstream.

In an embodiment, this flag is referred to vps_selection_flag. When vps_selection_flag is set to 1, then the dependency graph is indicated using the first method (global approach). When vps_selection_flag is set to 0, the dependency graph is indicated using the second method (local approach). This allows the application to select between two different methods to indicate dependency structure. An embodiment of this flag is shown in the View Parameter Set shown in Table 3. Table 3 shows the proposed View Parameter Set (VPS) syntax in accordance with an embodiment of the present principles. Table 4 shows the NAL unit type codes in accordance with an embodiment of the present principles. Table 5 shows the slice header syntax in accordance with an embodiment of the present principles. Table 6 shows the proposed Sequence Parameter Set (SPS) syntax in accordance with an embodiment of the present principles. Table 7 shows the proposed Picture Parameter Set (PPS) syntax in accordance with an embodiment of the present principles.

TABLE 3

| view_parameter_set_rbsp( ) { | | Descriptor |
|---|---|---|
| | view_parameter_set_id | ue(v) |
| | vps_selection_flag | u(1) |
| | if(vps_selection_flag) { | |

| | |
|---|---|
| num_multiview_refs_for_list0 | ue(v) |
| num_multiview_refs_for_list1 | ue(v) |
| for( i = 0; i < num_multiview_refs_for_list0; i++ ) { | |

| | |
|---|---|
| reference_view_for_list_0[i] | ue(v) |

}
for( i = 0; i < num_multiview_refs_for_list1; i++ ) {

| | |
|---|---|
| reference_view_for_list_1[i] | ue(v) |

}

} else {

| | |
|---|---|
| view_parameter_set_id | ue(v) |
| number_of_views_minus_1 | ue(v) |
| avc_compatible_view_id | ue(v) |
| for( i = 0; i <= number_of_views_minus_1; i++ ) { | |

| | |
|---|---|
| is_base_view_flag[i] | u(1) |

| | |
|---|---|
| dependency_update_flag | u(1) |

if(dependency_update_flag == 1) {

| | |
|---|---|
| for(j = 0; j < number_of_views_minus_1; j++) { | |
| anchor_picture_dependency_maps[i][j] | f(1) |
| if (anchor_picture_dependency_maps[i][j] == 1) | |

| | |
|---|---|
| non_anchor_picture_dependency_maps[i][j] | f(1) |

}

}

}

}

TABLE 4

| | NAL unit type codes | |
|---|---|---|
| nal_unit_type | Content of NAL unit and RBSP syntax structure | C |
| 0 | Unspecified | |
| 1 | Coded slice of a non-IDR picture | 2, 3, 4 |
| | slice_layer_without_partitioning_rbsp( ) | |
| 2 | Coded slice data partition A | 2 |
| | slice_data_partition_a_layer_rbsp( ) | |
| 3 | Coded slice data partition B | 3 |
| | slice_data_partition_b_layer_rbsp( ) | |
| 4 | Coded slice data partition C | 4 |
| | slice_data_partition_c_layer_rbsp( ) | |
| 5 | Coded slice of an IDR picture | 2, 3 |
| | slice_layer_without_partitioning_rbsp( ) | |
| 6 | Supplemental enhancement information (SEI) | 5 |
| | sei_rbsp( ) | |
| 7 | Sequence parameter set | 0 |
| | seq_parameter_set_rbsp( ) | |
| 8 | Picture parameter set | 1 |
| | pic_parameter_set_rbsp( ) | |
| 9 | Access unit delimiter | 6 |
| | access_unit_delimiter_rbsp( ) | |
| 10 | End of sequence | 7 |
| | end_of_seq_rbsp( ) | |
| 11 | End of stream | 8 |
| | end_of_stream_rbsp( ) | |
| 12 | Filler data | 9 |
| | filler_data_rbsp( ) | |
| 13 | Sequence parameter set extension | 10 |
| | seq_parameter_set_extension_rbsp( ) | |
| 14 | View parameter set | 11 |
| | view_parameter_set_rbps( ) | |
| 15 . . . 18 | Reserved | |
| 19 | Coded slice of an auxiliary coded picture without partitioning | 2, 3, 4 |
| | slice_layer_without_partitioning_rbsp( ) | |
| 20 | Coded slice of a non-IDR picture in scalable extension | 2, 3, 4 |
| | slice_layer_in_scalable_extension_rbsp( ) | |
| 21 | Coded slice of an IDR picture in scalable extension | 2, 3 |
| | slice_layer_in_scalable_extension_rbsp( ) | |
| 22 | Coded slice of a non-IDR picture in multi-view extension | 2, 3, 4 |
| | slice_layer_in_mvc_extension_rbsp( ) | |
| 23 | Coded slice of an IDR picture in multi-view extension | 2, 3 |
| | slice_layer_in_mvc_extension_rbsp( ) | |
| 24 . . . 31 | Unspecified | |

TABLE 5

| slice_header( ) { | | C | Descriptor |
|---|---|---|---|
| | first_mb_in_slice | 2 | ue(v) |
| | slice_type | 2 | ue(v) |
| | pic_parameter_set_id | 2 | ue(v) |
| | if (nal_unit_type == 22 ∥ nal_unit_type == 23) { | | |

| | | |
|---|---|---|
| view_parameter_set_id | 2 | ue(v) |
| view_id | 2 | ue(v) |

| | | |
|---|---|---|
| } | | |
| frame_num | 2 | u(v) |
| if( !frame_mbs_only_flag ) { | | |

| | | |
|---|---|---|
| field_pic_flag | 2 | u(1) |
| if( field_pic_flag ) | | |

| | | |
|---|---|---|
| bottom_field_flag | 2 | u(1) |

}

........
}

TABLE 6

| seq_parameter_set_rbsp( ) { | | C | Descriptor |
|---|---|---|---|
| | profile_idc | 0 | u(8) |
| | ..... | | |
| | if( profile_idc = = MULTI_VIEW_PROFILE) { | | |

vps_selection_flag

}
if( profile_idc = = 100 || profile_idc = = 110 ||

| profile_idc = = 122 \|\| profile_idc = = 144 \|\| | | |
|---|---|---|
| profile_idc = = 83 \|\| profile_idc = = MULTI_VIEW_PROFILE) { | | |
| chroma_format_idc | 0 | ue(v) |

.....

}

TABLE 7

| pic_parameter_set_rbsp( ) { | | C | Descriptor |
|---|---|---|---|
| | pic_parameter_set_id | 1 | ue(v) |
| | seq_parameter_set_id | 1 | ue(v) |
| | entropy_coding_mode_flag | 1 | u(1) |

......

| | | |
|---|---|---|
| if( profile_idc = = MULTI_VIEW_PROFILE) { | 1 | u(1) |

| | | |
|---|---|---|
| vps_slection_flag | 1 | ue(v) |

| | |
|---|---|
| } | 1 |

.....
}

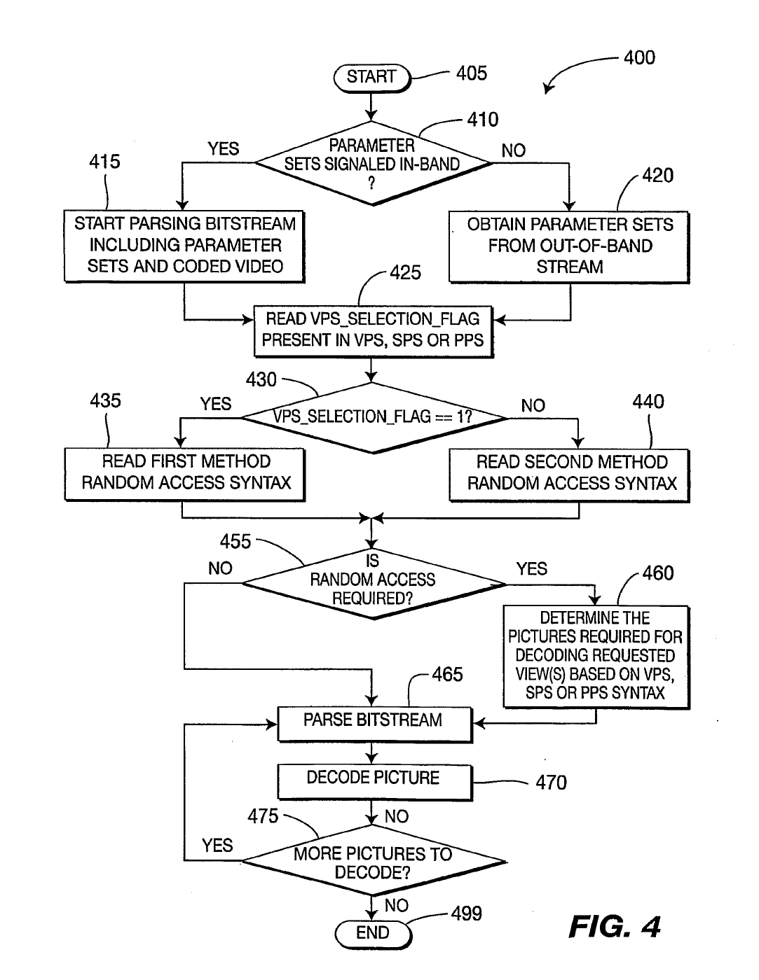

Turning to FIG. 3, an exemplary method for inserting a vps_selection_flag into a resultant bitstream is indicated generally by the reference numeral 300. The method 300 is particularly suitable for use in encoding multiple views corresponding to multi-view video content.

The method 300 includes a start block 305 that passes control to a function block 310. The function block 310 provides random access method selection criteria, and passes control to a decision block 315. The decision block 315 determines whether or not the first method syntax is to be used for the random access. If so, then control is passed to a function block 320. Otherwise, control is passed to a function block 335.

The function block 320 sets vps_selection_flag equal to one, and passes control to a function block 325. The function block 325 writes the first method random access syntax in a View Parameter Set (VPS), a Sequence Parameter Set (SPS), or a Picture Parameter Set (PPS) and passes control to a function block 350.

The function block 350 reads encoder parameters, and passes control to a function block 355. The function block 355 encodes the picture, and passes control to a function block 360. The function block 360 writes the bitstream to a file or stream, and passes control to a decision block 365. The decision block 365 determines whether or not more pictures are to be encoded. If so, then control is returned to the function block 355 (to encode the next picture). Otherwise, control is passed to a decision block 370. The decision block 370 determines whether or not the parameters are signaled in-band. If so, then control is passed to a function block 375. Otherwise, control is passed to a function block 380.

The function block 375 writes the parameter sets as part of the bitstream to a file or streams the parameter sets along with the bitstream, and passes control to an end block 399.

The function block 380 streams the parameter sets separately (out-of-band) compared to the bitstream, and passes control to the end block 399.

The function block 335 sets vps_selection_flag equal to zero, and passes control to a function block 340. The function block 340 writes the second method random access syntax in the VPS, SPS, or PPS, and passes control to the function block 350.

Turning to FIG. 4, an exemplary method for decoding a vps_selection_flag in a bitstream is indicated generally by the reference numeral 400. The method 400 is particularly suitable for use in decoding multiple views corresponding to multi-view video content.

The method 400 includes a start block 405 that passes control to a function block 410. The function block 410 determines whether or not the parameter sets are signaled in-band. If so, then control is passed to a function block 415. Otherwise, control is passed to a function block 420.

The function block 415 starts parsing the bitstream including parameter sets and coded video, and passes control to a function block 425.

The function block 425 reads the vps_selection_flag present in the View Parameter Set (VPS), the Sequence Parameter Set (SPS), or the Picture Parameter Set (PPS), and passes control to a decision block 430.

The decision block 430 determines whether or not vps_selection_flag is equal to one. If so, then control is passed to a function block 435. Otherwise, control is passed to a function block 440.

The function block 435 reads the first method random access syntax, and passes control to a decision block 455, and passes control to a decision block 455. The decision block 455 determines whether or not random access is required. If so, then control is passed to a function block 460. Otherwise, control is passed to a function block 465.

The function block 460 determines the pictures required for decoding the requested view(s) based on the VPS, SPS, or PPS syntax, and passes control to the function block 465.

The function block 465 parses the bitstream, and passes control to a function block 470. The function block 470 decodes the picture, and passes control to a decision block 475. The decision block 475 determines whether or not there are more pictures to decode. If so, then control is returned to the function block 465. Otherwise, control is passed to an end block 499.

The function block 420 obtains the parameter sets from the out-of-band stream, and passes control to the function block 425.

The function block 440 reads the second method random access syntax, and passes control to the decision block 455.

A description will now be given of some of the many attendant advantages/features of the present invention, some of which have been mentioned above. For example, one advantage/feature is an apparatus that includes an encoder for encoding at least two views corresponding to multi-view video content into a resultant bitstream using a syntax element. The syntax element identifies a particular one of at least two methods that indicate a decoding dependency between at least some of the at least two views. Another advantage/feature is the apparatus having the encoder as described above, wherein the syntax element is a high level syntax element. Yet another advantage/feature is the apparatus having the encoder as described above, wherein the high level syntax is provided out of band with respect to the resultant bitstream. Still another advantage/feature is the apparatus having the encoder as described above, wherein the high level syntax is provided in-band with respect to the resultant bitstream. Moreover, another advantage/feature is the apparatus having the encoder as described above, wherein the syntax element is present in a parameter set of the resultant bitstream. Further, another advantage/feature is the apparatus having the encoder as described above, wherein the parameter set is one of a View Parameter Set, a Sequence Parameter Set, or a Picture Parameter Set. Also, another advantage/feature is the apparatus having the encoder as described above, wherein the syntax element is a binary valued flag. Moreover, another advantage/feature is the apparatus having the encoder wherein the syntax element is a binary valued flag as described above, wherein the flag is denoted by a vps_selection_flag element. Further, another advantage/feature is the apparatus having the encoder wherein the syntax element is a binary valued flag as described above, wherein the flag is present a level higher than a macroblock level in the resultant bitstream. Also, another advantage/feature is the apparatus having the encoder wherein the syntax element is a binary valued flag present at the level higher than the macroblock level as described above, wherein the level corresponds to a parameter set of the resultant bitstream. Moreover, another advantage/feature is the apparatus having the encoder wherein the syntax element is at a level corresponding to a parameter set as described above, wherein the parameter set is one of a Sequence Parameter Set, a Picture Parameter Set, or a View Parameter Set.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
an encoder for encoding at least two views corresponding to multi-view video content into a resultant bitstream using a syntax element, wherein the syntax element identifies a particular one of at least two methods that indicate a decoding dependency between at least some of the at least two views.

2. The apparatus of claim 1, wherein the syntax element is a high level syntax element.

3. The apparatus of claim 1, wherein the high level syntax is provided out of band with respect to the resultant bitstream.

4. The apparatus of claim 1, wherein the high level syntax is provided in-band with respect to the resultant bitstream.

5. The apparatus of claim 1, wherein the syntax element is present in a parameter set of the resultant bitstream.

6. The apparatus of claim 5, wherein the parameter set is one of a View Parameter Set, a Sequence Parameter Set, or a Picture Parameter Set.

7. The apparatus of claim 1, wherein the syntax element is a binary valued flag.

8. The apparatus of claim 7, wherein the flag is denoted by a vps_selection_flag element.

9. The apparatus of claim 7, wherein the flag is present at a level higher than a macroblock level in the resultant bitstream.

10. The apparatus of claim 9, wherein the level corresponds to a parameter set of the resultant bitstream.

11. The apparatus of claim 10, wherein the parameter set is one of a Sequence Parameter Set, a Picture Parameter Set, or a View Parameter Set.

12. A method, comprising:
encoding at least two views corresponding to multi-view video content into a resultant bitstream using a syntax element, wherein the syntax element identifies a particular one of at least two methods that indicate a decoding dependency between at least some of the at least two views.

13. The method of claim 12, wherein the syntax element is a high level syntax element.

14. The method of claim 12, wherein the high level syntax is provided out of band with respect to the resultant bitstream.

15. The method of claim 12, wherein the high level syntax is provided in-band with respect to the resultant bitstream.

16. The method of claim 12, wherein the syntax element is present in a parameter set of the resultant bitstream.

17. The method of claim 16, wherein the parameter set is one of a View Parameter Set, a Sequence Parameter Set, or a Picture Parameter Set.

18. The method of claim 12, wherein the syntax element is a binary valued flag.

19. The method of claim 18, wherein the flag is denoted by a vps_selection_flag element.

20. The method of claim 18, wherein the flag is present at a level higher than a macroblock level in the resultant bitstream.

21. The method of claim 20, wherein the level corresponds to a parameter set of the resultant bitstream.

22. The method of claim 21, wherein the parameter set is one of a Sequence Parameter Set, a Picture Parameter Set, or a View Parameter Set.

23. An apparatus, comprising:
a decoder for decoding at least two views corresponding to multi-view video content from a bitstream using a syntax element, wherein the syntax element identifies a particular one of at least two methods that indicate a decoding dependency between at least some of the at least two views.

24. The apparatus of claim 23, wherein the syntax element is a high level syntax element.

25. The apparatus of claim 23, wherein the high level syntax is provided out of band with respect to the resultant bitstream.

26. The apparatus of claim 23, wherein the high level syntax is provided in-band with respect to the resultant bitstream.

27. The apparatus of claim 23, wherein the syntax element is present in a parameter set of the resultant bitstream.

28. The apparatus of claim 31, wherein the parameter set is one of a View Parameter Set, a Sequence Parameter Set, or a Picture Parameter Set.

29. The apparatus of claim 23, wherein the syntax element is a binary valued flag.

30. The apparatus of claim 29, wherein the flag is denoted by a vps_selection_flag element.

31. The apparatus of claim 29, wherein the flag is present at a level higher than a macroblock level in the resultant bitstream.

32. The apparatus of claim 31, wherein the level corresponds to a parameter set of the resultant bitstream.

33. The apparatus of claim 32, wherein the parameter set is one of a Sequence Parameter Set, a Picture Parameter Set, or a View Parameter Set.

34. A method, comprising:
decoding at least two views corresponding to multi-view video content from a bitstream using a syntax element, wherein the syntax element identifies a particular one of at least two methods that indicate a decoding dependency between at least some of the at least two views.

35. The method of claim 34, wherein the syntax element is a high level syntax element.

36. The method of claim 34, wherein the high level syntax is provided out of band with respect to the resultant bitstream.

37. The method of claim 34, wherein the high level syntax is provided in-band with respect to the resultant bitstream.

38. The method of claim 34, wherein the syntax element is present in a parameter set of the resultant bitstream.

39. The method of claim 41, wherein the parameter set is one of a View Parameter Set, a Sequence Parameter Set, or a Picture Parameter Set.

40. The method of claim 34, wherein the syntax element is a binary valued flag.

41. The method of claim 40, wherein the flag is denoted by a vps_selection_flag element.

42. The method of claim 40, wherein the flag is present at a level higher than a macroblock level in the resultant bitstream.

43. The method of claim 42, wherein the level corresponds to a parameter set of the resultant bitstream.

44. The method of claim 43, wherein the parameter set is one of a Sequence Parameter Set, a Picture Parameter Set, or a View Parameter Set.

45. A video signal structure for video encoding,
comprising:
at least two views corresponding to multi-view video content encoded into a resultant bitstream using a syntax element, wherein the syntax element identifies a particular one of at least two methods that indicate a decoding dependency between at least some of the at least two views.

46. A storage media having video signal data encoded thereupon, comprising:
at least two views corresponding to multi-view video content encoded into a resultant bitstream using a syntax element, wherein the syntax element identifies a particular one of at least two methods that indicate a decoding dependency between at least some of the at least two views.
